(19) United States
(12) Patent Application Publication
(10) Pub. No.: US 2008/0305834 A1
(43) Pub. Date: Dec. 11, 2008

(54) Method and apparatus for providing local multimedia content at a mobile wireless base station using a satellite receiver

(76) Inventors: Thomas John Janiszewski, Andover, NJ (US); James William McGowan, Whitehouse Station, NJ (US); Michael Charles Recchione, Nutley, NJ (US)

Correspondence Address: Lucent Technologies Inc.;Docket Administrator - Room 2F-190, 600 Mountain Avenue, Murray Hill, NJ, 07974-0636, US

(21) Appl. No.: 11/811,326

(22) Filed: Jun. 7, 2007

(51) Int. Cl. H04B 1/38

(52) U.S. Cl. 455/561

(57) ABSTRACT

An enhanced Base Transceiver Stations (BTS) includes a satellite receiver for use in receiving video and/or data signals. Since most video services (and many data services) are updated relatively infrequently, and since most such services require that the majority of traffic be sent from the core to the client (as opposed to from the client to the core), delivering such services over a satellite channel advantageously provides an opportunity to offer broadcast services, for example, with minimal use of the existing backhaul network, thereby advantageously eliminating the bottleneck typically created by the limited bandwidth of the backhaul network which is conventionally used to supply such video and/or data signals.

### CROSS-REFERENCE TO RELATED APPLICATIONS

The present application is related to U.S. patent application Ser. No. 11/614,371, entitled “Methods and Apparatus for Distributed Multimedia Content Supporting User Mobility,” and U.S. patent application Ser. No. 11/614,398, entitled “Methods and Apparatus for a Virtual Content Channel Structure in a Broadband Wireless Network with Location-Based Content,” each of which was filed on Dec. 21, 2006 and each of which assigned to the assignee of the present invention. U.S. patent application Ser. No. 11/614,371 and U.S. patent application Ser. No. 11/614,398 are each hereby incorporated by reference as if fully set forth herein.

### FIELD OF THE INVENTION

The present invention relates generally to the field of wireless communications techniques and more particularly to a method and apparatus for providing local multimedia content at a mobile wireless base station.

### BACKGROUND OF THE INVENTION

Current EV-DO (Evolution-Data Optimized) mobile communication networks comprise a core wired network, remote mobile Base Transceiver Stations (BTSs or “Base Stations” for short), and a “backhaul” link connecting the two. Mobile terminals such as cell phones or wireless laptops communicate with the BTS via a radio link or “air interface”. In current systems, the capacity of the air interface has exceeded the capacity of the backhaul network, shifting the historical bottleneck from air to wire. Mobile networks of all types, including UMTS (Universal Mobile Telecommunications System) have similar components and limitations. We will, without limitation, refer specifically herein to EV-DO network terminology, but the general case applies equally to other networks as well.

The current backhaul link for the majority of EV-DO BTSs in the United States are “T1” lines, fully familiar to those of ordinary skill in the art, having roughly 1.5 Mbps (Million bits per second) of bandwidth—as compared to over 3 Mbps for a single, ideal over-the-air interface. One T1 line often serves many air interfaces, supporting as much as 50 Mbps of air bandwidth. To deliver many advanced services, however, either higher-bandwidth fiber optics or additional T1 lines need to be connected to each BTS. Fiber is expensive and deployment thereof has been slower than anticipated. Service assurance policies on T1 lines make them prohibitively expansive. Accordingly, many new services are either not offered, or are shut down if they become too popular and require too much bandwidth—an ironic situation for service providers trying to sell new services. Video signals in particular require substantial bandwidth, and therefore, widespread deployment of video services in mobile communications systems cannot be economically supported, primarily because of the limitations of the backhaul network bottleneck.

### SUMMARY OF THE INVENTION

The present invention provides one novel solution to the backhaul network bottleneck when it is desired to provide video services, for example, in a mobile communications network. In particular, and in accordance with the principles of the present invention, an enhanced BTS includes a satellite receiver for use in receiving video and/or data signals. Since most video services (and many data services) are updated relatively infrequently, and since most such services require that the majority of traffic be sent from the core to the client (as opposed to from the client to the core), delivering such services over a satellite channel advantageously provides an opportunity to offer broadcast services, for example, with minimal use of the existing backhaul network, thereby advantageously eliminating the existing bottleneck thereof.

In accordance with one illustrative embodiment of the present invention, a satellite dish is physically connected to an EV-DO BTS (either directly or indirectly through an adjunct device), and in accordance with the operation of the illustrative embodiment, video and/or data signals may be received by the BTS through the satellite dish (rather than through the backhaul network, which comprises the aforementioned bottleneck). More generally, however, various illustrative embodiments of the present invention may comprise a secondary content resource such as, for example, a satellite dish, which is advantageously placed between an end device (e.g., a mobile terminal) and a primary content resource (e.g., a core network), with a controller (e.g., as may be comprised in an enhanced BTS) which advantageously manages communications with both resources.

Although caching mechanisms or “web caches” are well-known prior art approaches to solving the backhaul network bottleneck problem, the novel approach of the illustrative embodiments of the present invention differs from these prior art techniques in that caching mechanisms simply acquire content from primary sources, and then store such acquired content locally. In accordance with certain illustrative embodiments of the present invention, however, although secondary content may be advantageously stored locally as well, it is initially acquired from a secondary source (rather than from a primary source). The illustrative embodiments of the present invention also differ from commonly available network elements that have multiple connections to primary resources that are otherwise undifferentiated. Finally, the illustrative embodiments of the present invention also differ from prior art media gateways, since media gateways do not receive and serve broadcast content. However, in accordance with one illustrative embodiment of the present invention, an EV-DO BTS may advantageously host a satellite receiver using a media gateway as an intermediary.

### BRIEF DESCRIPTION OF THE DRAWINGS

FIG. 1 shows a prior art mobile communications network having a conventional Base Transceiver Station (BTS) which receives video signals from a Core Network via a Backhaul Link.

FIG. 2 shows a mobile communications network in accordance with an illustrative embodiment of the present invention having a Base Transceiver Station (BTS) which advantageously receives video signals from a satellite receiver.

### DETAILED DESCRIPTION OF THE PREFERRED EMBODIMENTS

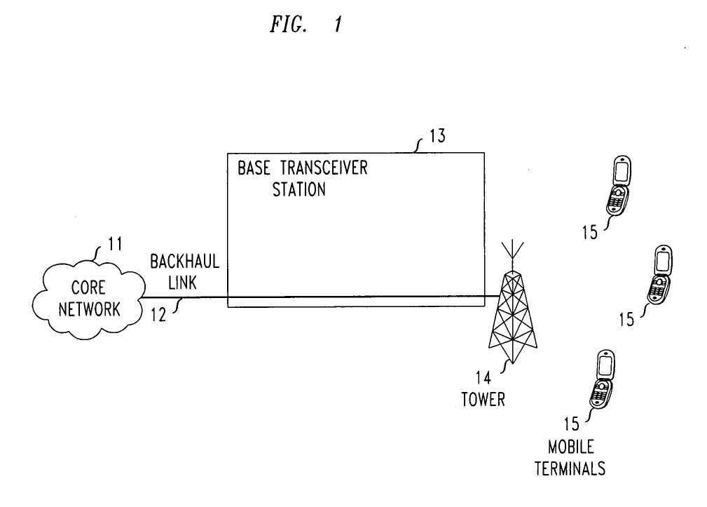

FIG. 1 shows a prior art mobile communications network having a conventional Base Transceiver Station (BTS) which receives video signals from a Core Network via a Backhaul Link. The mobile communications network of FIG. 1 comprises a core network 11 connected to a Base Transceiver Station (BTS) 13 with use of backhaul link 12 (which is part of a conventional backhaul network). The BTS is also connected to tower 14 which is used by the BTS to communicate over an air interface with a plurality of mobile terminals 15. All of these components are conventional and will be fully familiar to those of ordinary skill in the art.

In the prior art network of FIG. 1, when video services are to be provided to one or more of mobile terminals 15, the required video content is received by BTS 13 from core network 11 via backhaul link 12. As pointed out above, due to the substantial amount of bandwidth typically required for video services, together with the limited capacity of typical backhaul networks, backhaul link 12 often results in a bottleneck for the delivery of such video services.

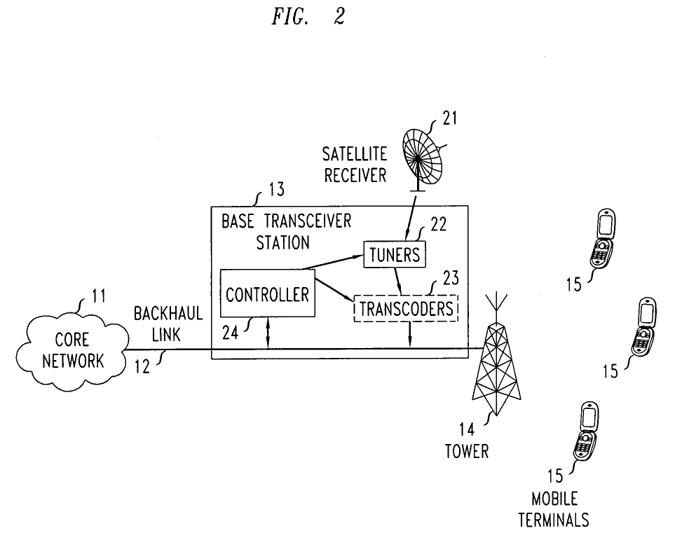

FIG. 2 shows a mobile communications network in accordance with an illustrative embodiment of the present invention having a Base Transceiver Station (BTS) which advantageously receives video traffic from a satellite receiver. In addition to core network 11, Base Transceiver Station (BTS) 13, backhaul link 12 (which is part of a conventional backhaul network), tower 14, and the plurality of mobile terminals 15, as shown in the prior art network of FIG. 1, the illustrative mobile communications network of FIG. 2 comprises satellite receiver 21, a controller 24, tuners 22, and (optional) transcoder box 23.

Operationally, BTS 13 advantageously makes the (e.g., video) content accessible to the mobile terminals without it having traversed the backhaul network and backhaul link 12. However, as will be clear to those skilled in the art, the video may not be usable in the form output directly from a satellite dish. Thus, in accordance with the illustrative embodiment of the present invention shown in FIG. 2, tuners 22 are advantageously provided to select a particular broadcast channel from the receiver. (Note that such tuners are commonly required components of either televisions or set-top boxes used in home cable and satellite television systems.) Typically, one tuner is required per decoded channel, and thus, regardless of the number of channels the satellite dish can actually receive, the number that can be viewed simultaneously is usually equal only to the number of tuners. Specifically, therefore, controller 24 operates to control tuners 22 in response, for example, to requests from mobile terminal users for particular video content.

In addition, in accordance with the illustrative embodiment of the present invention shown in FIG. 2, (optional) transcoder box 23 may be provided to convert the video output from each of the tuners into a specifically appropriate format for distribution to the mobile stations. For example, note that the video from a satellite receiver is typically received in MPEG-2 format, a standard video coding format fully familiar to those of ordinary skill in the art. A transcoder, such as those that may be provided in transcoder box 23, may, for example, be used to advantageously convert the MPEG-2 format video to MPEG-4 layer 10—which is also known as H.264—and to reduce the image to a size more appropriate for a mobile phone screen. (MPEG-4 layer 10 or H.264 are also standard video coding formats fully familiar to those of ordinary skill in the art.) Note also that since multiple users may be watching the same content on devices with different capabilities (e.g., small cell phone screens, large laptop screens, etc.), the number of transcoders comprised in transcoder box 23 may advantageously be at least equal to the number of simultaneous viewers. However, in accordance with some illustrative embodiments of the present invention, it is possible that a mobile user will be able to receive content in the form in which it is received by the satellite dish, either because, for example, the mobile user can view MPEG-2 content directly, or because a channel has been optimized for a particular purpose—such as, for example, a channel specifically designed to broadcast MPEG-4 Layer 10 encoded content with a size, frame rate and bit rate which is appropriate for a mobile phone.

In various alternative illustrative embodiments of the present invention, satellite receiver 21 may be inserted in the network anywhere between the mobile terminals and backhaul link 12. Accordingly, traffic may be directed from the satellite receiver to the mobile terminal, advantageously bypassing the backhaul bottleneck. In the operation of various illustrative embodiments of the present invention, the satellite receiver may receive broadcast television, satellite radio, generic data service, etc. Also, as pointed out above, alternate types of receivers (i.e., other than a satellite receiver) may be advantageously used in various alternative embodiments of the present invention.

Note that since the connection between the terminal and the network is a potentially unreliable radio link, the effective bandwidth may vary over time. Accordingly, the transcoder in accordance with certain illustrative embodiments of the present invention may advantageously modify the bit rate of the video stream to adapt to the existing network conditions. Such a capability may require that each terminal have its own transcoder box, since each user may see unique radio conditions.

In accordance with various illustrative embodiments of the present invention, the content from the illustrative Satellite Receiver of FIG. 2 may be delivered to the mobile terminals either in-band with all other content, or on a separate radio path. The use of the in-band approach may be supplemented by a method to inject local content at the base station with the content already flowing between a Mobile Terminal and the Core Network. One such method may, for example, be found in U.S. patent application Ser. No. 11/614,371 (“Methods and Apparatus for Distributed Multimedia Content Supporting User Mobility”) which has been incorporated by reference herein. (See above.) The use of the separate radio path approach is similar to that of traditional broadcast television or ATSC, with the exception that the existing data channel on the mobile terminal may be advantageously used for authentication, billing, etc., and that the user can move from one source to another. Such separate radio path solutions are used in current mobile network offerings, and will be fully familiar to those skilled in the art.

### ADDENDUM TO THE DETAILED DESCRIPTION

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A base station in a wireless network for delivering content to one or more mobile terminals, the base station comprising:
a controller, said controller operative in response to a request to deliver one or more selected content signals to one or more of said mobile terminals;
a backhaul link connecting the base station to a backhaul network; and
one or more tuners, controlled by said controller, for receiving an output signal from a content receiver and for generating said one or more selected content signals therefrom,
wherein said content receiver receives content from a content source external to the base station, and wherein said content is not received by said content receiver with use of said backhaul link or said backhaul network.

2. The base station of claim 1 wherein said content receiver is contained within said base station.

3. The base station of claim 1 wherein said content receiver is external to said base station but provides said output signal to said base station.

4. The base station of claim 1 wherein said content receiver comprises a satellite dish.

5. The base station of claim 1 further comprising one or more transcoders, controlled by said controller, each of said transcoders for converting a corresponding one of said selected content signals generated by said one or more tuners from a first signal format into a second signal format.

6. The base station of claim 5 wherein said first signal format comprises an MPEG-2 video format and wherein said second signal format comprises an MPEG-4 layer 10 video format.

7. The base station of claim 6 wherein said second signal format comprises an MPEG-4 layer 10 video format having a size, frame rate, and bit rate adapted to characteristics of one or more of said mobile terminals.

8. The base station of claim 5 wherein said one or more transcoders is adapted to modify a bit rate of said second signal format based at least in part on current network conditions associated with said wireless network.

9. The base station of claim 1 wherein said one or more selected content signals is delivered to said one or more mobile terminals in-band with the delivery of wireless network content received from said backhaul network.

10. The base station of claim 1 wherein said one or more selected content signals is delivered to said one or more mobile terminals with use of a radio path which is distinct from a radio path used to deliver wireless network content received from said backhaul network.

11. The base station of claim 1 wherein said content comprises video content.

12. The base station of claim 1 wherein said content comprises audio content.

13. The base station of claim 1 wherein said content comprises generic data.

14. A method for delivering content to one or more mobile terminals by a base station in a wireless network, the base station including a controller, a backhaul link connecting the base station to a backhaul network, and one or more tuners, the method comprising the steps of:
receiving, with use of the controller, a request to deliver one or more selected content signals to one or more of said mobile terminals;
receiving, with use of said one or more tuners, an output signal from a content receiver; and
generating, with use of said one or more tuners, said one or more selected content signals from said output signal from said content receiver,
wherein said content receiver receives content from a content source external to the base station, and wherein said content is not received by said content receiver with use of said backhaul link or said backhaul network.

15. The method of claim 14 wherein the base station further includes one or more transcoders, and wherein the method further comprises the step of converting, with use of said one or more transcoders, corresponding ones of said selected content signals generated by said one or more tuners from a first signal format into a second signal format.

16. The method of claim 15 wherein said first signal format comprises an MPEG-2 video format and wherein said second signal format comprises an MPEG-4 layer 10 video format.

17. The method of claim 16 wherein said second signal format comprises an MPEG-4 layer 10 video format having a size, frame rate, and bit rate adapted to characteristics of one or more of said mobile terminals.

18. The method of claim 15 further wherein said step of one converting said selected content signals from a first signal format into a second signal format comprises modifying a bit rate of said second signal format based at least in part on current network conditions associated with said wireless network.

19. The method of claim 14 further comprising the step of delivering said one or more selected content signals to said one or more mobile terminals in-band with the delivery of wireless network content received from said backhaul network.

20. The method of claim 14 further comprising the step of delivering said one or more selected content signals to said one or more mobile terminals with use of a radio path which is distinct from a radio path used to deliver wireless network content received from said backhaul network.
